(19) United States
(12) Patent Application Publication
(10) Pub. No.: US 2006/0073280 A1
(43) Pub. Date: Apr. 6, 2006

(54) Method for producing uv abbsorption layers on substrates

(76) Inventors: Michael Bauer, Forchheim (DE); Andreas Baranyai, Heitersheim (DE); Martin Kunz, Efringen-Kirchen (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/530,614

(22) PCT Filed: Oct. 8, 2003
(86) PCT No.: PCT/EP03/11133

§ 371 Date: Apr. 7, 2005

(30) Foreign Application Priority Data
Oct. 9, 2002 (DE) 102-47-125.8

(51) Int. Cl. B05D 3/00

(52) U.S. Cl. 427/372.2; 427/532; 427/551; 427/553

(57) ABSTRACT

A process for forming UV absorber layers on an inorganic or organic substrate is described. That process comprises a) allowing a low-temperature plasma, a corona discharge or high-energy radiation to act on the inorganic or organic substrate, b) applying to the treated inorganic or organic substrate at least one free-radical-forming initiator and at least one UV absorber containing at least one ethylenically unsaturated group, and, optionally in the form of melts, solutions, suspensions or emulsions, at least one synergist and/or at least one ethylenically unsaturated compound, c) heating the coated substrate and/or irradiating it with electromagnetic waves. The invention relates also to a substrate provided with a UV absorber layer in accordance with that process. That process substantially eliminates vacuum conditions and excessive thermal stress or energy stress and also destruction of the UV absorber. Clear, transparent UV absorber layers that exhibit good adhesion are formed, the properties of which, such as, for example, the optical density, are advantageously controllable.

The invention relates to a process for forming a coherent UV-absorbing layer on organic or inorganic substrates.

U.S. Pat. No. 5,156,882 describes the production of UV-absorbing layers from TiO₂ or other transition metal oxides, which layers are obtained by means of plasma-assisted deposition. A problem that arises in the deposition of inorganic oxides is that usually only inadequate adhesion to the substrates is achieved and it is therefore necessary to construct intermediate layers, for example of SiO₂, in addition. Such UV-absorbing inorganic layers are generally not completely transparent in the visible range, which is a disadvantage for many applications.

In order to overcome that disadvantage, attempts have been made to produce UV-absorbing coatings by the deposition of purely organic layers using plasma processes. Thus, a PECVD (plasma enhanced chemical vapor deposition) process for the production of UV-absorbing layers is described, for example, in DE-A-195 22 865, that uses compounds containing a structural element of formula (A):

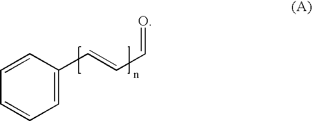

JP 6-25448, of 1 Feb. 1994, describes a process for the plasma polymerisation of known UV absorbers, such as phenyl salicylates, 2-hydroxybenzophenones, hydroxyphenyl benzotriazoles and cyanoacrylates, on polymer materials.

WO 99/55471 describes the plasma-assisted vacuum deposition of triazine UV absorbers, in which process the UV absorbers are vaporised and, during deposition on the substrate, are simultaneously exposed to a plasma. It is necessary, however, for the process to be carried out in vacuo, and the substances are subjected to high temperatures (for the vaporisation) and exposed to high levels of energy (UV light and high-energy species from the plasma).

The plasma-assisted deposition of organic compounds frequently leads to unforeseeable modifications of the structures at the molecular level. Degradation reactions and other changes occur especially when functional groups are present in the molecule. Functional groups can readily be oxidised or split off in the plasma. In addition, the molecules used may be completely destroyed by the short-wave radiation and high-energy species, such as ions and free radicals, present in the plasma. The deposited film may therefore have much lower or completely different absorption properties, and hence also different protecting properties, from those of the compound originally used. In addition to the absorption, the photochemical stability of the deposited compound in the film may differ from that of the original compound, so that the long-term protecting action of the deposited film may differ substantially from that which would be expected with the original compound in a conventional coating.

The plasma techniques mentioned also need to be performed in vacuo and accordingly necessitate complex apparatus and time-consuming procedures. Furthermore, the compounds to be applied or to be polymerised need to be vaporised and recondensed on the substrate, which may lead to high levels of thermal stress and, in many cases, to decomposition. In addition, the vaporisation and deposition rates are low, with the result that the production of layers that are of adequate thickness and/or have an appropriately high level of absorption is difficult and laborious.

Surprisingly, a process has now been found that makes it possible to produce UV-absorbing layers without the above disadvantages.

The invention relates to a process for forming a coherent UV-absorbing layer on organic or inorganic substrates which comprises a) allowing a low-temperature plasma, a corona discharge and/or high-energy radiation to act on the inorganic or organic substrate, b) applying to the treated inorganic or organic substrate at least one free-radical-forming initiator and at least one UV absorber containing at least one ethylenically unsaturated group, and, optionally in the form of melts, solutions, suspensions or emulsions, at least one synergist and/or at least one ethylenically unsaturated compound, and c) heating the coated substrate and/or irradiating it with electromagnetic waves.

The advantages of that process are, on the one hand, that with such a procedure it is possible to avoid vacuum conditions. Excessive thermal stress or energy stress on or destruction of the UV absorbers is also entirely avoided. Compared with spectra of the UV absorbers in solution, the absorption spectra of the generated layers show no change, indicating that the molecular structure is fully retained. Using the described process, clear transparent layers, which also exhibit good adhesion, are formed on the substrates. In combination with ethylenically mono- or poly-unsaturated compounds (monomers or oligomers), it is possible for the mechanical properties of the layers produced to be varied within wide limits. Thick UV absorber layers can be obtained quickly and simply and control of the optical density is likewise simplified. The protecting action can be further enhanced by combination with light stabilisers.

In the case of organic substrates, especially polymers, protection and stabilisation against damage by UV rays has hitherto been achieved by incorporating UV absorbers into the bulk of the materials. However a high concentration of the UV absorbers is desirable in areas close to the surface, since that is where the light intensity is at its highest and consequently also damage at its greatest. In order to achieve adequate protection in areas close to the surface, a relatively high concentration, up to 5 percent by weight, of UV absorber needs to be used, but the UV absorber is uniformly distributed in the material and is present also in areas into which no or only little UV light is able to penetrate. Since light has only a limited depth of penetration, it is not capable of passing into deeper-lying layers, and in such areas a smaller concentration or no UV absorber would be necessary. This means that, with the conventional procedure, too much absorber has to be used. With the process described herein, because the UV absorber is located only where it is needed, that is to say at the surface of the material, the amount thereof to be used can be appreciably reduced.

The substrates may be in the form of a powder, a fiber, a felt, a woven fabric, a film or a moulding or three-dimensional workpiece. Preferred substrates are synthetic or natural polymers, metal oxides, glass, semi-conductors, quartz or metals, or materials containing such substances. Especially preferred substrates are those which contain homopolymers, block polymers, graft polymers and/or copolymers. As a semi-conductor substrate there may be mentioned especially silicon, which, for example, may be in the form of “wafers”. Metals that may be mentioned are especially aluminium, chromium, steel, vanadium, which are used for the production of high-quality mirrors, for example telescope mirrors or vehicle headlamp reflectors. Aluminium is especially preferred.

Examples of natural and synthetic polymers or plastics are listed below.
i) Polymers of mono- and di-olefins, for example polypropylene, polyisobutylene, polybutene-1, poly-4-methylpentene-1, polyisoprene or polybutadiene and also polymerisates of cyclo-olefins, for example of cyclopentene or norbornene; and also polyethylene (which may optionally be crosslinked), for example high density polyethylene (HDPE), high density polyethylene of high molecular weight (HDPE-HMW), high density polyethylene of ultra-high molecular weight (HDPE-UHMW), medium density polyethylene (MDPE), low density polyethylene (LDPE), and linear low density polyethylene (LLDPE), (VLDPE) and (ULDPE);
ii) mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE);
iii) copolymers of mono- and di-olefins with one another or with other vinyl monomers, for example ethylene/propylene copolymers, linear low density polyethylene (LLDPE) and mixtures thereof with low density polyethylene (LDPE), propylene/butene-1 copolymers, propylene/isobutylene copolymers, ethylene/butene-1 copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and copolymers thereof with carbon monoxide, or ethylene/acrylic acid copolymers and salts thereof (ionomers), and also terpolymers of ethylene with propylene and a diene, such as hexadiene, dicyclopentadiene or ethylidenenorbornene; and also mixtures of such copolymers with one another or with polymers mentioned under 1), for example polypropylene-ethylene/propylene copolymers, LDPE-ethylene/vinyl acetate copolymers, LDPE-ethylene/acrylic acid copolymers, LLDPE-ethylene/vinyl acetate copolymers, LLDPE-ethylene/acrylic acid copolymers and alternately or randomly structured polyalkylene-carbon monoxide copolymers and mixtures thereof with other polymers, for example polyamides;
iv) hydrocarbon resins (for example C₅-C₉) including hydrogenated modifications thereof (for example tackifier resins) and mixtures of polyalkylenes and starch;
v) polystyrene, poly(p-methylstyrene), poly(α-methylstyrene);
vi) copolymers of styrene or α-methylstyrene with dienes or acrylic derivatives, for example styrene/butadiene, styrene/acrylonitrile, styrene/alkyl methacrylate, styrene/butadiene/alkyl acrylate and methacrylate, styrene/maleic anhydride, styrene/acrylonitrile/methyl acrylate; high-impact-strength mixtures consisting of styrene copolymers and another polymer, for example a polyacrylate, a diene polymer or an ethylene/propylene/diene terpolymer; and also block copolymers of styrene, for example styrene/butadiene/styrene, styrene/isoprene/styrene, styrene/ethylene-butylene/styrene or styrene/ethylene-propylene/styrene;
vii) graft copolymers of styrene or α-methylstyrene, for example styrene on polybutadiene, styrene on polybutadiene/styrene or polybutadiene/acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleic acid imide on polybutadiene; styrene and maleic acid imide on polybutadiene, styrene and alkyl acrylates or alkyl methacrylates on polybutadiene, styrene and acrylonitrile on ethylene/propylene/diene terpolymers, styrene and acrylonitrile on polyalkyl acrylates or polyalkyl methacrylates, styrene and acrylonitrile on acrylate/butadiene copolymers, and mixtures thereof with the copolymers mentioned under 6), such as those known, for example, as so-called ABS, MBS, ASA or AES polymers;
viii) halogen-containing polymers, for example polychloroprene, chlorinated rubber, chlorinated and brominated copolymer of isobutylene/isoprene (halobutyl rubber), chlorinated or chlorosulfonated polyethylene, copolymers of ethylene and chlorinated ethylene, epichlorohydrin homo- and co-polymers, especially polymers of halogen-containing vinyl compounds, for example polyvinyl chloride, polyvinylidene chloride, polyvinyl fluoride, polyvinylidene fluoride; and copolymers thereof, such as vinyl chloride/vinylidene chloride, vinyl chloride/vinyl acetate or vinylidene chloride/vinyl acetate.
ix) polymers derived from α,β-unsaturated acids and derivatives thereof, such as polyacrylates and polymethacrylates, or polymethyl methacrylates, polyacrylamides and polyacrylonitriles impact-resistant-modified with butyl acrylate;

x) copolymers of the monomers mentioned under 9) with one another or with other unsaturated monomers, for example acrylonitrile/butadiene copolymers, acrylonitrile/alkyl acrylate copolymers, acrylonitrile/alkoxyalkyl acrylate copolymers, acrylonitrile/vinyl halide copolymers or acrylonitrile/alkyl methacrylate/butadiene terpolymers;

xi) polymers derived from unsaturated alcohols and amines or their acyl derivatives or acetals, such as polyvinyl alcohol, polyvinyl acetate, stearate, benzoate or maleate, polyvinylbutyral, polyallyl phthalate, polyallylmelamine; and the copolymers thereof with olefins mentioned in Point 1;
xii) homo- and co-polymers of cyclic ethers, such as polyalkylene glycols, polyethylene oxide, polypropylene oxide or copolymers thereof with bisglycidyl ethers;
xiii) polyacetals, such as polyoxymethylene, and also those polyoxymethylenes which contain comonomers, for example ethylene oxide; polyacetals modified with thermoplastic polyurethanes, acrylates or with MBS;
xiv) polyphenylene oxides and sulfides and mixtures thereof with styrene polymers or polyamides;
xv) polyurethanes derived from polyethers, polyesters and polybutadienes having terminal hydroxyl groups on the one hand and aliphatic or aromatic polyisocyanates on the other hand, and their initial products;
xvi) polyamides and copolyamides derived from diamines and dicarboxylic acids and/or from aminocarboxylic acids or the corresponding lactams, such as polyamide 4, polyamide 6, polyamide 6/6, 6/10, 6/9, 6/12, 4/6, 12/12, polyamide 11, polyamide 12, aromatic polyamides derived from m-xylene, diamine and adipic acid; polyamides prepared from hexamethylene-diamine and iso- and/or terephthalic acid and optionally an elastomer as modifier, for example poly-2,4,4-trimethylhexamethylene terephthalamide or poly-m-phenylene isophthalamide. Block copolymers of the above-mentioned polyamides with polyolefins, olefin copolymers, ionomers or chemically bonded or grafted elastomers; or with polyethers, for example with polyethylene glycol, polypropylene glycol or polytetramethylene glycol. Also polyamides or copolyamides modified with EPDM or with ABS; and polyamides condensed during processing (“RIM polyamide systems”);
xvii) polyureas, polyimides, polyamide imides, polyether imides, polyester imides, polyhydantoins and polybenzimidazoles;
xviii) polyesters derived from dicarboxylic acids and dialcohols and/or from hydroxy-carboxylic acids or the corresponding lactones, such as polyethylene terephthalate, polybutylene terephthalate, poly-1,4-dimethylolcyclohexane terephthalate, polyhydroxy benzoates, and also block polyether esters derived from polyethers with hydroxyl terminal groups; and also polyesters modified with polycarbonates or with MBS;
xix) polycarbonates and polyester carbonates;
xx) polysulfones, polyether sulfones and polyether ketones;
xxi) crosslinked polymers derived from aldehydes on the one hand and phenols, urea or melamine on the other hand, such as phenol-formaldehyde, urea-formaldehyde and melamine-formaldehyde resins;
xxii) drying and non-drying alkyd resins;
xxiii) unsaturated polyester resins derived from copolyesters of saturated and unsaturated dicarboxylic acids with polyhydric alcohols, and from vinyl compounds as crosslinking agents, and also the halogen-containing, difficultly combustible modifications thereof;
xxiv) crosslinkable acrylic resins derived from substituted acrylic acid esters, e.g. from epoxy acrylates, urethane acrylates or polyester acrylates;
xxv) alkyd resins, polyester resins and acrylate resins that are crosslinked with melamine resins, urea resins, isocyanates, isocyanurates, polyisocyanates or epoxy resins;
xxvi) crosslinked epoxy resins derived from aliphatic, cycloaliphatic, heterocyclic or aromatic glycidyl compounds, e.g. products of diglycidyl ethers of bisphenol A, diglycidyl ethers of bisphenol F, which are crosslinked using customary hardeners, e.g. anhydrides or amines with or without accelerators;
xxvii) natural polymers, such as cellulose, natural rubber, gelatin, or polymer-homologously chemically modified derivatives thereof, such as cellulose acetates, propionates and butyrates, and the cellulose ethers, such as methyl cellulose; and also colophonium resins and derivatives;
xxviii) mixtures (polyblends) of the afore-mentioned polymers, for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

In the case of natural polymers, there may be mentioned as being especially preferred carbon fibres, cellulose, starch, cotton, rubber, colophonium, wood, flax, sisal, polypeptides, polyamino acids and derivatives thereof.

The synthetic polymer is preferably a polycarbonate, polyester, halogen-containing polymer, polyacrylate, polyolefin, polyamide, polyurethane, polystyrene and/or polyether.

The synthetic materials can be in the form of films, injection-moulded articles, extruded workpieces, fibers, felts or woven fabrics. In addition to components for the automotive industry, articles such as spectacles or contact lenses may also be provided with a thin UV-absorbing layer.

Possible ways of obtaining plasmas under vacuum conditions have been described frequently in the literature. The electrical energy can be coupled in by inductive or capacitive means. It may be direct current or alternating current; the frequency of the alternating current may vary from a few kHz up into the MHz range. A power supply in the microwave range (GHz) is also possible. The principles of plasma generation and maintenance are described, for example, by A. T. Bell, “Fundamentals of Plasma Chemistry” in “Technology and Application of Plasma Chemistry”, edited by J. R. Holahan and A. T. Bell, Wiley, N.Y. (1974) or by H. Suhr, Plasma Chem. Plasma Process 3(1),1, (1983).

The plasma gas used can be either an inert gas or a mixture of inert gas and reactive gas. As primary plasma gases there may be used, for example, He, Ar, Kr, Xe N₂, O₂, H₂, steam or air. The process according to the invention is not per se sensitive with respect to the coupling-in of electrical energy. The process can be carried out in batch operation, for example in a rotating drum, or, in the case of films, fibers or woven fabrics, in continuous operation. Such procedures are known and are described in the prior art.

The process can also be carried out under corona discharge conditions. Corona discharges are generated under normal pressure conditions, the ionised gas most frequently used being air. In principle, however, other gases and mixtures are also possible, as described, for example, in COATING Vol. 2001, No. 12, 426, (2001). The advantage of air as ionising gas in corona discharges is that the procedure can be carried out in apparatus that is open to the outside and that, for example, a film can be drawn through continuously between the discharge electrodes. Such process arrangements are known and are described, for example, in J. Adhesion Sci. Technol. Vol 7, No. 10, 1105, (1993). Three-dimensional workpieces can be treated using a free plasma jet, the contours being followed with the assistance of robots.

The process can be performed within a wide pressure range, the discharge characteristics being shifted, as pressure increases, from a pure low-temperature plasma towards corona discharge and finally, at atmospheric pressure of approximately 1000-1100 mbar, changing into a corona discharge.

Preferably, the process is carried out at a process pressure of from 10⁻⁶ mbar up to atmospheric pressure (1013 mbar), especially at atmospheric pressure in the form of a corona process. Preferably, the process is carried out by using, as plasma gas, an inert gas or a mixture of inert gas with reactive gas. Where a corona discharge is used, the gas used is preferably air, CO₂ and/or nitrogen. Preferably, H₂, CO₂, He, Ar, Kr, Xe, N₂, O₂ and H₂O are used as plasma gases, either individually or in the form of a mixture. Especially advantageous results are obtained when the treatment of the inorganic or organic substrate a) is carried out for a duration of from 1 ms to 300 s, especially from 10 ms to 200 s.

As free-radical-forming initiators there come into consideration all compounds or mixtures of compounds that generate one or more free radicals when heated and/or irradiated with electromagnetic waves. Such initiators include, in addition to compounds or combinations that are usually thermally activated, such as, for example, peroxides and hydroperoxides (also in combination with accelerators, such as amines and/or cobalt salts), and amino ethers (NOR compounds), also photochemically activatable compounds (e.g. benzoins) or combinations of chromophores with coinitiators (e.g. benzophenone and tertiary amines) or mixtures thereof. It is also possible to use sensitisers with coinitiators (e.g. thioxanthones with tertiary amines) or chromophores (e.g. thioxanthones with aminoketones). Redox systems, such as, for example, combinations of H₂O₂ with iron(II) salts, can likewise be used. It is also possible to use electron-transfer pairs, such as, for example, dyes and borates and/or amines. There may be used as initiator a compound or a combination of compounds from the following classes: peroxides, peroxodicarbonates, persulfates, benzpinacols, dibenzyls, disulfides, azo compounds, redox systems, benzoins, benzil ketals, acetophenones, hydroxyalkylphenones, aminoalkylphenones, acylphosphine oxides, acylphosphine sulfides, acyloxyiminoketones, a peroxy compound, halogenated acetophenones, phenyl glyoxalates, benzophenones, oximes and oxime esters, thioxanthones, camphorquinones, ferrocenes, titanocenes, sulfonium salts, iodonium salts, diazonium salts, onium salts, alkyl borides, borates, triazines, bisimidazoles, polysilanes and/or dyes, and also corresponding coinitiators and/or sensitisers.

Preferred compounds are: dibenzoyl peroxide, benzoyl peroxide, dicumyl peroxide, cumyl hydroperoxide, diisopropyl peroxydicarbonate, methyl ethyl ketone peroxide, bis(4-tert-butyl-cyclohexyl) peroxydicarbonate, ammonium peroxomonosulfate, ammonium peroxodisulfate, dipotassium persulfate, disodium persulfate, N,N-azobisisobutyronitrile, 2,2′-azobis(2,4-dimethylpentanenitrile), 2,2′-azobis(2-methylpropanenitrile), 2,2′-azobis(2-methylbutanenitrile), 1,1′-azobis(cyanocyclohexane), tert-amyl peroxobenzoate, 2,2′-bis(tert-butylperoxy)-butane, 1,1′-bis(tert-butylperoxy)cyclohexane, 2,5-bis(tert-butylperoxy)-2,5-dimethylhexane, 2,5-bis(tert-butylperoxy)-2,5-dimethyl-3-hexyne, 1,1-bis(tert-butylperoxy)-3,3,5-trimethyl-cyclohexane, tert-butyl hydroperoxide, tert-butyl peracetate, tert-butyl peroxide, tert-butyl peroxybenzoate, tert-butyl peroxyisopropyl carbonate, cyclohexanone peroxide, lauroyl peroxide, 2,4-pentanedione peroxide, 2,5-dimethyl-2,5-di(tert-butylperoxy)hexane, di(2-tert-butyl-peroxyisopropyl)benzene, cobalt octanoate, dicyclopentadienylchromium, peracetic acid, benzpinacol and dibenzyl derivatives, such as dimethyl-2,3-diphenylbutane, 3,4-dimethyl-3,4-diphenylhexane, poly-1,4-diisopropylbenzene, N,N-dimethylcyclohexyl-ammonium dibutyldithiocarbamate, N-tert-butyl-2-benzothioazole sulfenamide, benzothiazyl disulfide and tetrabenzylthiuram disulfide.

Typical examples of photoactivatable systems, which can be used either individually or in mixtures, are mentioned below. For example benzophenones, benzophenone derivatives, acetophenone, acetophenone derivatives, such as, for example, α-hydroxycycloalkyl phenyl ketones or 2-hydroxy-2-methyl-1-phenyl-propanone, dialkoxyacetophenones, α-hydroxy- or α-amino-acetophenones, such as, for example, (4-methylthiobenzoyl)-1-methyl-1-morpholino-ethane, (4-morpholino-benzoyl)-1-benzyl-1-dimethylaminopropane, 4-aroyl-1,3-dioxolanes, benzoin alkyl ethers and benzil ketals, such as, for example, benzil dimethyl ketal, phenylglyoxalates and derivatives thereof, dimeric phenylglyoxalates, monoacylphosphine oxides, such as, for example, (2,4,6-trimethylbenzoyl)phenylphosphine oxide, bisacylphosphine oxides, such as, for example, bis(2,6-dimethoxybenzoyl)-(2,4,4-trimethyl-pent-1-yl)phosphine oxide, bis(2,4,6-trimethylbenzoyl)phenylphosphine oxide or bis(2,4,6-trimethylbenzoyl)-(2,4-dipentyloxyphenyl)phosphine oxide, trisacylphosphine oxides, ferrocenium compounds or titanocenes, such as, for example, (η⁵-2,4-cyclopentadien-1-yl)[1,2,3,4,5,6-η)-(1-methylethyl)benzene]iron(+)-hexafluorophosphate(−1) or dicyclopentadienyl-bis(2,6-difluoro-3-pyrrolophenyl)titanium; sulfonium and iodonium salts, such as, for example, bis[4-(diphenylsulfonio)phenyl]sulfide bishexafluorophosphate, (4-isobutylphenyl)-p-tolyl-iodonium hexafluorophosphate.

As coinitiators there come into consideration, for example, photosensitisers, which shift or broaden the spectral sensitivity and thus bring about an acceleration of the photopolymerisation. Such photosensitisers are especially aromatic carbonyl compounds, for example benzophenone derivatives, thioxanthone derivatives, especially also isopropyl-thioxanthone, anthraquinone derivatives and 3-acylcoumarin derivatives, triazines, coumarins, terphenyls, styryl ketones, and also 3-(aroylmethylene)-thiazolines, camphorquinone, and also eosin, rhodamine and erythrosine dyes. As coinitiators it is also possible to use tert-amines, thiols, borates, phenylglycines, phosphines and other electron donors.

Further examples of photosensitisers are
i) thioxanthones, such as
thioxanthone, 2-isopropylthioxanthone, 2-chlorothioxanthone, 2-dodecylthioxanthone, 2,4-diethylthioxanthone, 2,4-dimethylthioxanthone, 1-methoxycarbonylthioxanthone, 2-ethoxycarbonylthioxanthone, 3-(2-methoxyethoxycarbonyl)thioxanthone, 4-butoxycarbonylthioxanthone, 3-butoxycarbonyl-7-methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 3,4-di[2-(2-methoxyethoxy)ethoxycarbonyl]thioxanthone, 1-ethoxycarbonyl-3-(1-methyl-1-morpholinoethyl)thioxanthone, 2-methyl-6-dimethoxymethylthioxanthone, 2-methyl-6-(1,1-dimethoxybenzyl)thioxanthone, 2-morpholinomethylthioxanthone, 2-methyl-6-morpholinomethylthioxanthone, N-allylthioxanthone-3,4-dicarboximide, N-octylthioxanthone-3,4-dicarboximide, N-(1,1,3,3-tetramethylbutyl)thioxanthone-3,4-dicarboximide, 1-phenoxythioxanthone, 6-ethoxycarbonyl-2-methoxythioxanthone, 6-ethoxycarbonyl-2-methylthioxanthone, thioxanthone-2-polyethylene glycol ester, 2-hydroxy-3-(3,4-dimethyl-9-oxo-9H-thioxanthon-2-yloxy)-N,N,N-trimethyl-1-propanaminium chloride;
ii) benzophenones, such as
benzophenone, 4-phenylbenzophenone, 4-methoxybenzophenone, 4,4′-dimethoxybenzophenone, 4,4′-dimethylbenzophenone, 4,4′-dichlorobenzophenone, 4,4′-dimethylaminobenzophenone, 4,4′-diethylaminobenzophenone, 4-methylbenzophenone, 2,4,6-trimethylbenzophenone, 4-(4-methylthiophenyl)-benzophenone, 3,3′-dimethyl-4-methoxybenzophenone, methyl 2-benzoylbenzoate, 4-(2-hydroxyethylthio)-benzophenone, 4-(4-tolylthio)-benzophenone, 4-benzoyl-N,N,N-trimethylbenzenemethanaminium chloride, 2-hydroxy-3-(4-benzoylphenoxy)-N,N,N-trimethyl-1-propanaminium chloride monohydrate, 4-(13-acryloyl-1,4,7,10,13-pentaoxatridecyl)-benzophenone, 4-benzoyl-N,N-dimethyl-N-[2-(1-oxo-2-propenyl)oxy]ethylbenzenemethanaminium chloride;
iii) 3-acylcoumarins, such as
3-benzoylcoumarin, 3-benzoyl-7-methoxycoumarin, 3-benzoyl-5,7-di(propoxy)coumarin, 3-benzoyl-6,8-dichlorocoumarin, 3-benzoyl-6-chlorocoumarin, 3,3′-carbonyl-bis[5,7-di-(propoxy)coumarin], 3,3′-carbonyl-bis(7-methoxycoumarin), 3,3′-carbonyl-bis(7-diethylaminocoumarin), 3-isobutyroylcoumarin, 3-benzoyl-5,7-dimethoxycoumarin, 3-benzoyl-5,7-diethoxycoumarin, 3-benzoyl-5,7-dibutoxycoumarin, 3-benzoyl-5,7-di(methoxyethoxy)-coumarin, 3-benzoyl-5,7-di(allyloxy)coumarin, 3-benzoyl-7-dimethylaminocoumarin, 3-benzoyl-7-diethylaminocoumarin, 3-isobutyroyl-7-dimethylaminocoumarin, 5,7-dimethoxy-3-(1-naphthoyl)-coumarin, 5,7-dimethoxy-3-(1-naphthoyl)-coumarin, 3-benzoylbenzo[f]coumarin, 7-diethylamino-3-thienoylcoumarin, 3-(4-cyanobenzoyl)-5,7-dimethoxycoumarin;
iv) 3-(aroylmethylene)thiazolines, such as
3-methyl-2-benzoylmethylene-β-naphthothiazoline, 3-methyl-2-benzoylmethylene-benzothiazoline, 3-ethyl-2-propionylmethylene-β-naphthothiazoline;
v) other carbonyl compounds, such as
acetophenone, 3-methoxyacetophenone, 4-phenylacetophenone, benzil, 2-acetyinaphthalene, 2-naphthaldehyde, 9,10-anthraquinone, 9-fluorenone, dibenzosuberone, xanthone, 2,5-bis(4-diethylaminobenzylidene)cyclopentanone, α-(para-dimethylaminobenzylidene)-ketones, such as 2-(4-dimethylaminobenzylidene)indan-1-one or 3-(4-dimethylaminophenyl)-1-indan-5-yl-propenone, 3-phenylthiophthalimide, N-methyl-3,5-di(ethylthio)phthalimide, N-methyl-3,5-di(ethylthio)phthalimide.

As UV absorbers there come into consideration compounds from the classes of the hydroxyphenyl-benzotriazoles, hydroxyphenyl-benzophenones, oxalic acid amides, triazines, oxalanilides, cyanoacrylates, salicylic acids, or hydroxyphenylpyrimidines.

As ethylenically unsaturated groups there come into consideration especially those that are capable of being free-radically polymerised; in addition to vinyl and vinylidene groups there may be mentioned especially acrylic, methacrylic, allyl, styryl and vinyl ether groups. Examples of triazines having unsaturated groups are described in WO 99/55471. EP 0 722 938 B1 describes, for example, the preparation of berizotriazoles having unsaturated double bonds. Benzotriazoles and benzophenones having ethylenically unsaturated groups are likewise described in U.S. Pat. No. 4,880,859, as are also cinnamic acid derivatives. Further corresponding benzotriazoles are described in EP 0 488 145 B1, EP 0 747 755 B1, U.S. Pat. No. 5,334,235 and Research Disclosure May 1991 Pos. 32592.

The following compounds are preferred: 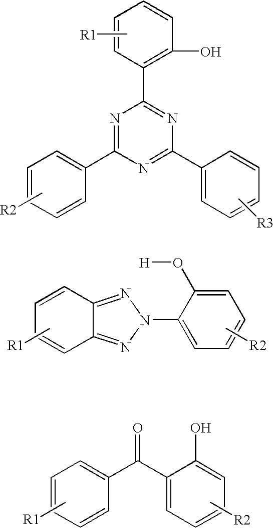
wherein R1 to R3 may each independently of the others be H, linear or branched alkyl groups, substituted or unsubstituted aryl groups, or ethylenically unsaturated groups bonded directly or via spacer groups, and 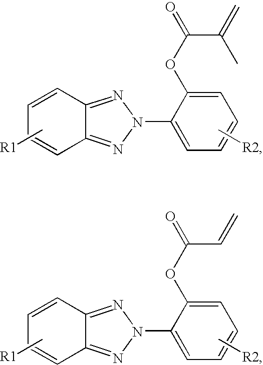
wherein R1 and R2 may each independently of the other be H, linear or branched alkyl groups, or substituted or unsubstituted aryl groups.

The following compounds are especially preferred:

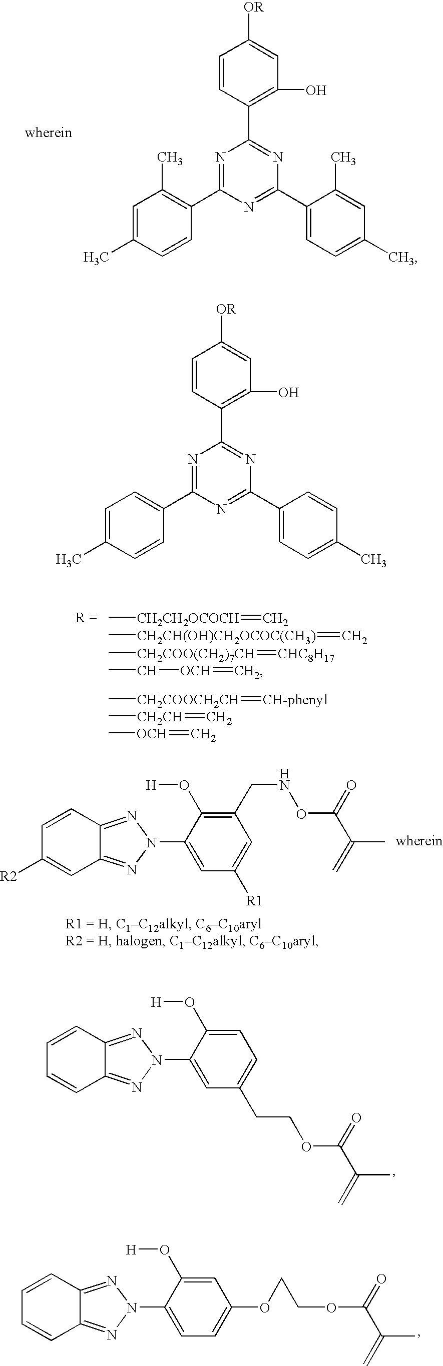

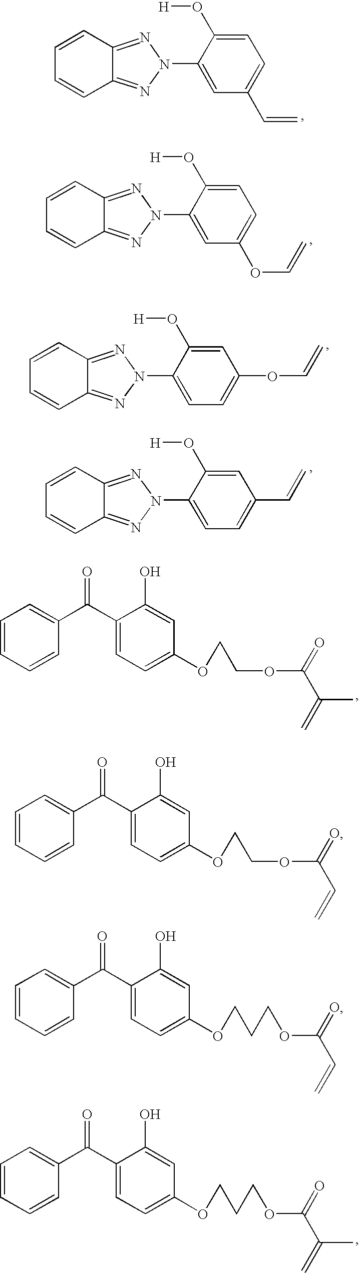

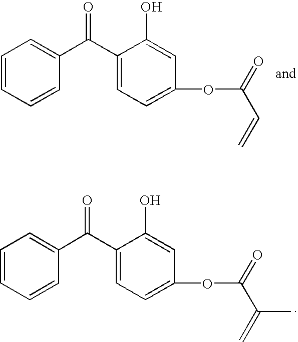

The following compounds are also preferred: α-cyano-β,β-diphenylacrylic acid ethyl ester and isooctyl ester, α-carbomethoxycinnamic acid methyl ester, α-cyano-β-methyl-p-methoxy-cinnamic acid methyl ester and butyl ester, α-carbomethoxy-p-methoxycinnamic acid methyl ester, N-(β-carbomethoxy-β-cyanovinyl)-2-methylindoline, N-(phthalimido-methyl)acrylamide, vinyl phenyl acetate, 9-vinylanthracene, phenyl methacrylate, 2-phenyl-ethyl acrylate, 2-phenylethyl methacrylate, 4-(2-acryloxyethoxy)-2-hydroxybenzophenone, 3-allyl-4-hydroxyacetophenone.

The ethylenically unsaturated compounds may contain one or more olefinic double bonds. They may be low molecular weight (monomeric) or higher molecular weight (oligomeric, polymeric). Examples of monomers having a double bond are alkyl and hydroxyalkyl acrylates and methacrylates, e.g. methyl, ethyl, butyl, 2-ethylhexyl and 2-hydroxyethyl acrylate, isobornyl acrylate and methyl and ethyl methacrylate. Silicone acrylates are also of interest. Further examples are acrylonitrile, acrylamide, methacrylamide, N-substituted (meth)acrylamides, vinyl esters, such as vinyl acetate, vinyl ethers, such as isobutyl vinyl ether, styrene, alkyl- and halo-styrenes, N-vinylpyrrolidone, vinyl chloride and vinylidene chloride. The ethylenically unsaturated monomers, oligomers and/or polymers are especially mono-, di-, tri-, tetra- or multi-functional vinyl ethers, acrylates and/or methacrylates.

Examples of monomers having double bonds are ethylene glycol diacrylate, propylene glycol diacrylate, neopentyl glycol diacrylate, hexamethylene glycol diacrylate and bisphenol-A diacrylate, 4,4′-bis(2-acryloyloxyethoxy)diphenylpropane triacrylate, trimethylolpropane triacrylate, pentaerythritol triacrylate and pentaerythritol tetraacrylate, vinyl acrylate, divinyl benzene, divinyl succinate, diallyl phthalate, triallyl phosphate, triallyl isocyanurate, tris(hydroxyethyl)isocyanurate triacrylate and tris(2-acryloylethyl)isocyanurate.

Examples of higher molecular weight (oligomeric) polyunsaturated compounds are acrylated epoxy resins, acrylated or vinyl-ether- or epoxy-group-containing polyesters, polyurethanes and polyethers. Further examples of unsaturated oligomers are unsaturated polyester resins, which are usually produced from maleic acid, phthalic acid and one or more diols and have molecular weights of about from 500 to 3000. In addition it is also possible to use vinyl ether monomers and oligomers, and also maleate-terminated oligomers having polyester, polyurethane, polyether, polyvinyl ether and epoxide main chains. Especially combinations of vinyl-ether-group-carrying oligomers and polymers, such as are described in WO 90/01512, are very suitable, but copolymers of monomers functionalised with maleic acid and vinyl ether also come into consideration. Such unsaturated oligomers can also be referred to as prepolymers.

There are especially suitable, for example, esters of ethylenically unsaturated carboxylic acids and polyols or polyepoxides, and polymers having ethylenically unsaturated groups in the chain or in side groups, e.g. unsaturated polyesters, polyamides and polyurethanes and copolymers thereof, alkyd resins, polybutadiene and butadiene copolymers, polyisoprene and isoprene copolymers, polymers and copolymers having (meth)acrylic groups in side chains, and also mixtures of one or more such polymers.

Examples of unsaturated carboxylic acids are acrylic acid, methacrylic acid, crotonic acid, itaconic acid, cinnamic acid and unsaturated fatty acids such as linolenic acid and oleic acid. Acrylic and methacrylic acid are preferred.

Suitable polyols are aromatic and especially aliphatic and cycloaliphatic polyols. Examples of aromatic polyols are hydroquinone, 4,4′-dihydroxydiphenyl, 2,2-di(4-hydroxyphenyl)-propane, and novolaks and resols. Examples of polyepoxides are those based on the said polyols, especially the aromatic polyols and epichlorohydrin. Also suitable as polyols are polymers and copolymers that contain hydroxyl groups in the polymer chain or in side groups, e.g. polyvinyl alcohol and copolymers thereof or polymethacrylic acid hydroxyalkyl esters or copolymers thereof. Further suitable polyols are oligoesters having hydroxyl terminal groups.

Examples of aliphatic and cycloaliphatic polyols include alkylenediols having preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 to 1500, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may be partially or fully esterified by one or by different unsaturated carboxylic acid(s), it being possible for the free hydroxyl groups in partial esters to be modified, for example etherified, or esterified by other carboxylic acids.

Examples of esters are:
trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentaacrylate, sorbitol hexaacrylate, oligoester acrylates and methacrylates, glycerol di- and tri-acrylate, 1,4-cyclohexane diacrylate, bisacrylates and bismethacrylates of polyethylene glycol having a molecular weight of from 200 to 1500, and mixtures thereof.

Also suitable as a component are the amides of identical or different unsaturated carboxylic acids and aromatic, cycloaliphatic and aliphatic polyamines having preferably from 2 to 6, especially from 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, di-β-aminoethyl ether, diethylenetriamine, triethylenetetramine and di(β-aminoethoxy)- and di(β-aminopropoxy)-ethane. Further suitable polyamines are polymers and copolymers which may have additional amino groups in the side chain and oligoamides having amino terminal groups. Examples of such unsaturated amides are: methylene bisacrylamide, 1,6-hexamethylene bisacrylamide, diethylenetriamine trismethacrylamide, bis(methacrylamidopropoxy)ethane, β-methacrylamidoethyl methacrylate and N-[βhydroxyethoxy)ethyl]-acrylamide.

Suitable unsaturated polyesters and polyamides are derived, for example, from maleic acid and diols or diamines. The maleic acid may have been partially replaced by other dicarboxylic acids. They may be used together with ethylenically unsaturated comonomers, e.g. styrene. The polyesters and polyamides may also be derived from dicarboxylic acids and ethylenically unsaturated diols or diamines, especially from those having longer chains of e.g. from 6 to 20 carbon atoms. Examples of polyurethanes are those composed of saturated diisocyanates and unsaturated diols or unsaturated diisocyanates and saturated diols.

Polybutadiene and polyisoprene and copolymers thereof are known. Suitable comonomers include, for example, olefins, such as ethylene, propene, butene and hexene, (meth)acrylates, acrylonitrile, styrene and vinyl chloride. Polymers having (meth)acrylate groups in the side chain are likewise known. Examples are reaction products of novolak-based epoxy resins with (meth)acrylic acid; homo- or co-polymers of vinyl alcohol or hydroxyalkyl derivatives thereof that have been esterified with (meth)acrylic acid; and homo- and co-polymers of (meth)acrylates that have been esterified with hydroxyalkyl (meth)acrylates.

As mono- or poly-unsaturated olefinic compound there is especially preferably used a vinyl ether, acrylate or methacrylate compound. Polyunsaturated acrylate compounds, such as have already been listed hereinabove, are more especially preferred.

It is known from a large number of publications that UV absorbers in combination with other substances (synergists) enable especially effective protection to be achieved. Such synergists can likewise be used within the scope of the invention. Synergists are, for example, light stabilisers, free-radical acceptors, peroxide decomposers etc. Synergists are, for example, compounds from the classes of the sterically hindered amines, amino ethers (>NOR compounds), benzoxazines and/or thioethers. A number of compounds may be mentioned by way of example: bis(2,2,6,6-tetramethylpiperidyl) sebacate, bis(2,2,6,6-tetramethylpiperidyl) succinate, bis(1,2,2,6,6-pentamethylpiperidyl) sebacate, n-butyl-3,5-di-tert-butyl-4-hydroxybenzylmalonic acid bis(1,2,2,6,6-pentamethylpiperidyl) ester, the condensation product of 1-hydroxyethyl-2,2,6,6-tetramethyl-4-hydroxypiperidine and succinic acid, the condensation product of N,N′-bis(2,2,6,6-tetramethyl-4-piperidyl)hexamethylenediamine and 4-tert-octylamino-2,6-dichloro-1,3,5-s-triazine, tris(2,2,6,6-tetramethyl-4-piperidyl) nitrilotriacetate, tetrakis(2,2,6,6-tetramethyl-4-piperidyl) 1,2,3,4-butanetetraoate, 1,1′-(1,2-ethane-diyl)-bis(3,3,5,5-tetramethylpiperazinone), 4-benzoyl-2,2,6,6-tetramethylpiperidine, 4-stearyl-oxy-2,2,6,6-tetramethylpiperidine, bis(1,2,2,6,6-pentamethylpiperidyl) 2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl) sebacate, bis(1-octyloxy-2,2,6,6-tetramethylpiperidyl) succinate, the condensation product of N,N′-bis(2,2,6,6-tetramethyl-4-piperidyl) hexamethylenediamine and 4-morpholino-2,6-dichloro-1,3,5-triazine, the condensation product of 2-chloro-4,6-di(4-n-butylamino-2,2,6,6-tetramethylpiperidyl)-1,3,5-triazine and 1,2-bis(3-aminopropylamino)ethane, the condensation product of 2-chloro-4,6-di(4-n-butyl-amino-1,2,2,6,6-pentamethylpiperidyl)-1,3,5-triazine and 1,2-bis(3-aminopropylamino)-ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)-pyrrolidine-2,5-dione, 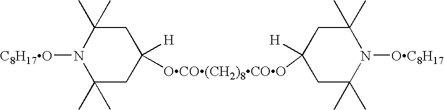
and reaction products of N,N′-ethane-1,2-diyl bis(1,3-propanediamine), cyclohexane, peroxidised 4-butylamino-2,2,6,6-tetramethylpiperidine and 2,4,6-trichloro-1,3,5-triazine.

In principle it is advantageous for the UV-absorber-containing solutions, suspensions or emulsions to be applied as quickly as possible, but for many purposes it may also be acceptable to carry out step b) with a time delay. Preferably, however, process step b) is carried out directly after or within 24 hours after process step a).

Application of the UV-absorber-containing melts, solutions, suspensions or emulsions can be carried out in a variety of ways. It can be effected by immersion, spraying, coating, brush application, knife application, rolling, roller application, printing, spin-coating and pouring.

Preferably, the concentration of initiators in the liquids to be applied is from 0.01 to 20%, especially from 0.1 to 5%, and that of UV absorbers from 0.1 to 99%, especially from 0.1 to 50%. Preferably, the concentration of ethylenically unsaturated compounds in those liquids is from 0.1 to 50%, preferably from 0.1 to 30%.

In mixtures of UV absorbers with one another, with light stabilisers and/or with ethylenically unsaturated compounds, all possible mixing ratios can be used. The ratios are matched to one another according to the nature of the later use, in order to optimise the optical, mechanical and/or other required properties.

The UV-absorber-containing liquids may additionally comprise other substances, for example defoamers, emulsifiers, surfactants, anti-fouling agents, wetting agents and other additives customary in the coatings and paints industry.

The thickness of the applied layer in the dry state is likewise matched to the requirements of the later use and ranges from a monomolecular layer up to 2 mm, preferably from 1 to 1000 μm.

In principle it is advantageous for the UV-absorber-containing solutions, suspensions or emulsions to be heated, dried or irradiated as rapidly as possible, since the layer is fixed and stabilised by means of that step, but it may also be acceptable for many purposes for step c) to be carried out with a time delay. Preferably, however, process step c) is carried out directly after or within 24 hours after process step b).

Many possible methods of heating/drying coatings are known and and they can all be used in the claimed process. Thus, for example, it is possible to use hot gases, IR radiators, ovens, heated rollers and/or microwaves. The temperatures used for that purpose are governed by the thermal stability of the materials used and generally range from 0 to 300° C.; preferably, they are from 0 to 200° C. If desired, a drying step is carried out beforehand.

In the case of materials that are especially temperature-sensitive, irradiation with electromagnetic waves may be advantageous. Care must be taken that the initiator used is one which absorbs also in the wavelength ranges in which the UV absorber exhibits no or only little absorption. If desired, a drying step is carried out beforehand. Irradiation of the coating can be carried out using any source that emits electromagnetic waves of wavelengths that can be absorbed by the photoinitiators employed. Such sources are generally those which emit electromagnetic radiation of wavelengths in the range from 200 nm to 20 000 nm. In addition to customary radiators and lamps, it is also possible to use lasers and LEDs (Light Emitting Diodes). The whole area or parts thereof can be irradiated. Partial irradiation is of advantage when only particular regions are to be rendered adherent. The irradiation can also be carried out using electron beams. The whole area and/or parts thereof can be irradiated, for example, by means of irradiation through a mask or using laser beams. By that means it is possible to achieve fixing and stabilisation in particular regions only. In unexposed regions, the layer could be washed off again and in that manner structuring achieved.

The heating/drying and/or irradiation can be carried out in air or under an inert gas. As inert gas, nitrogen gas comes into consideration, but other inert gases, such as CO₂ or argon, helium etc. or mixtures thereof, can also be used. Suitable systems and apparatus are known to the person skilled in the art and are obtainable commercially. The heating/drying can, however, also be carried out without inert gas, that is to say in air.

Also claimed are substrates having UV absorber layers, and also coatings, prepared in accordance with one of the processes described above. Such coatings are distinguished by an optical density of from 0.1 to 6, preferably from 0.5 to 4, especially from 1 to 3, in the absorption maximum of the UV absorber. In those coatings, the proportion of UV absorber is at least 10%, preferably at least 15%, and especially at least 20%.

The substrates provided with UV absorber can be used in many ways. Uses in which UV protection is to be achieved naturally predominate. The protection is capable of reducing or preventing oxidation, discoloration, bleaching or other damage and can be provided in the form of films that are applied to or encapsulate, either permanently or temporarily, a further substrate. The substrates are thus suitable for use as protecting and/or packaging materials for foodstuffs, chemicals, pharmaceuticals, textiles, animal feed, cosmetics, glass, plastics products, coatings and paints (liquid or already dried/cured), printing plates, agrochemicals, fertilisers, veterinary products and animal hygiene products. Such films can, in addition, be used to protect printed materials, for example paper, photographs, posters, plans, stickers, labels, advertising panels, illuminated advertising signs, sports articles, screens, etc. in order primarily to maintain their colour quality and to prolong their service life. The described films also fulfil their protecting function in the form of greenhouse films and other applications for sun and UV protection (for example disposable films for solariums).

The substrates provided with UV absorber can also be used in the form of containers, for example bottles, cans, buckets etc., and serve to protect foodstuffs, chemicals, pharmaceuticals, textiles, animal feed, cosmetics, glasses, plastics products, coatings and paints (liquid or already dried/cured), agrochemicals, herbicides, fungicides, fertilisers, veterinary products and animal hygiene products.

Possible uses in the form of three-dimensional components are, for example, lenses for lamps and/or headlamps, plastics windows, automobile components, sports equipment, containers etc.

A further application for substrates provided with UV absorber is their use as filters. Specific transmission values can be set by varying the layer thickness and/or the optical density of the UV absorber layer on organic or inorganic glasses. Filters of that kind can be used especially in optical applications, for example in photography, microscopy, or in the form of lenses, spectacles, contact lenses, magnifying glasses, telescopes, screens, binoculars and mirrors. Other possible uses for such filters are in enlargers, copying, projectors, lamps, solariums, and lighting and exposure equipment.

Also claimed are products provided with a coating according to any one of the preceding claims.

The following Examples illustrate the invention.

### EXAMPLE 1

A transparent polyvinyl chloride film (250 μm) is corona-treated in air four times, using a ceramic electrode (manual corona station type CEE 42-0-1 MD, width 330 mm, SOFTAL) at a distance of approximately from 1 to 2 mm, at an output of 600 W and at a treatment rate of 10 cm/s. An ethanolic solution containing 0.7% of the UV absorber having the following structural formula 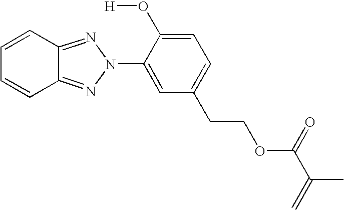
and 0.35% of 1,1-azobis(cyclohexanecarbonitrile) is applied to the treated side of the film using a 4 μm knife (Erichsen). The specimens are stored briefly until the alcohol has evaporated and the specimens are dry. They are then stored for 15 minutes at 80° C. in a drying cabinet. Transparent coatings are obtained and UV/visible spectra recorded in the transmission mode are identical to solution spectra and exhibit the absorption peak characteristic of the UV absorber at 345 nm.

### EXAMPLE 2

A transparent polyvinyl chloride film (250 μm) is corona-treated in air four times, using a ceramic electrode (manual corona station type CEE 42-0-1 MD, width 330 mm, SOFTAL) at a distance of approximately from 1 to 2 mm, at an output of 600 W and at a treatment rate of 10 cm/s. An ethanolic solution containing 0.7% of the UV absorber having the following structural formula 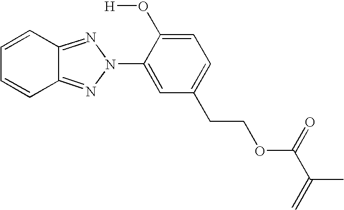
and 0.35% of 1,1-azobis(cyclohexanecarbonitrile) is applied to the treated side of the film using a 4 μm knife (Erichsen). The specimens are stored briefly until the alcohol has evaporated and the specimens are dry. Using a UV processor (Fusion Systems) having a microwave-excited mercury lamp and an output of 120 W/cm, they are then irradiated at a belt speed of 5 m/min. Transparent coatings are obtained and UV/visible spectra recorded in the transmission mode are identical to solution spectra and exhibit the absorption peak characteristic of the UV absorber at 345 nm.

### EXAMPLE 3

A transparent polyethylene film (150 μm) is corona-treated four times in air, using a ceramic electrode (manual corona station type CEE 42-0-1 MD, width 330 mm, SOFTAL) at a distance of approximately from 1 to 2 mm, at an output of 250 W and at a treatment rate of 10 cm/s. An acetone solution containing 5% of the UV absorber having the following structural formula 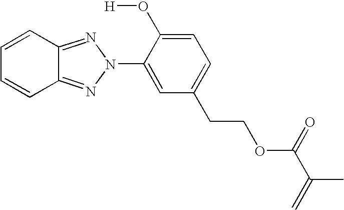
and 1% 1,1-azobis(cyclohexanecarbonitrile) and 2.5% tris(2-hydroxyethyl)isocyanurate triacrylate is applied to the treated side of the film using a 50 μm knife (Erichsen). The specimens are stored until the acetone has evaporated and the specimens are dry. They are then cured at 80° C. for one hour in a drying cabinet. The above-mentioned solution is applied a second time and cured in the manner described. Transparent stable coatings are obtained and, in the range from 290 nm to 360 nm, UV/visible spectra recorded in the transmission mode give optical densities of from 1.5 to 2.5.

### EXAMPLE 4

A transparent polyethylene film (150 μm) is corona-treated four times in air, using a ceramic electrode (manual corona station type CEE 42-0-1 MD, width 330 mm, SOFTAL) at a distance of approximately from 1 to 2 mm, at an output of 250 W and at a treatment rate of 10 cm/s. An acetone solution containing 5% of the UV absorber having the following structural formula 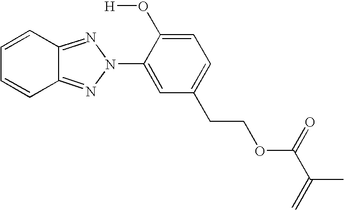
and 1% acrylic acid 2-[4-(2-hydroxy-2-methylpropionyl)phenoxy]ethyl ester and 1% tris(2-hydroxyethyl)isocyanurate triacrylate is applied to the treated side of the film using a 50 μm knife (Erichsen). The specimens are stored until the acetone has evaporated and the specimens are dry. Using a UV processor (Fusion Systems) having a microwave-excited mercury lamp and an output of 120 W/cm, they are then irradiated four times at a belt speed of 5 m/min. The above-mentioned solution is applied a second time and cured in the manner described. Transparent stable coatings are obtained and, in the range from 285 nm to 360 nm, UV/visible spectra recorded in the transmission mode give optical densities of from 1.5 to 2.4.

1. A process for forming a UV absorber layer on an inorganic or organic substrate, which process comprises
a) allowing a low-temperature plasma, a corona discharge or high-energy radiation to act on the inorganic or organic substrate,
b) applying to the treated inorganic or organic substrate at least one free-radical-forming initiator and at least one uv absorber containing at least one ethylenically unsaturated group, and, optionally in the form of melts, solutions, suspensions or emulsions, at least one synergist and/or at least one ethylenically unsaturated compound and
c) heating the coated substrate and/or irradiating it with electromagnetic waves.

2. A process according to claim 1, wherein the substrate coated is in the form of a powder, a fibre, a felt, a woven fabric, a film or a moulding.

3. A process according to claim 1, wherein the substrate is or comprises a synthetic polymer, a natural polymer, a metal oxide, a glass, a semi-conductor, quartz or a metal.

4. A process according to claim 1, wherein the substrate is or comprises a homopolymer, a block polymer, a graft polymer or a copolymer.

5. A process according to claim 1, wherein the organic substrate is or comprises a polycarbonate, polyester, halogen-containing polymer, polyacrylate, polyolefin, polyamide, polyurethane, polystyrene or polyether.

6. A process according to claim 1, where the initiator is a peroxide, peroxodicarbonate, persulfate, benzpinacol, dibenzyl, disulfide, an azo compound, a redox system, benzoin, benzil ketal, acetophenone, hydroxyalkylphenone, aminoalkylphenone, acylphosphine oxide, acylphosphine sulfide, acyloxyiminoketone, a peroxy compound, a halogenated acetophenone, phenyl glyoxylate, benzophenone, oxime, oxime ester, thioxanthone, ferrocene, titanocene, sulfonium salt, iodonium salt, diazonium salt, onium salt, borate, triazine, bisimidazole, polysilane or dye, there being present in addition, if desired, co-initiators and/or sensitisers.

7. A process according to claim 1, where the UV absorber is a hydroxyphenyl-benzotriazole, hydroxyphenyl-benzophenone, oxalic acid amide, triazine, oxalanilide, cyanoacrylate, salicylic acid or hydroxyphenylpyrimidine.

8. A process according to claim 1, which comprises applying a synergist, which is a sterically hindered amine, an amino ether (>NOR compound), a benzoxazine or a thioether.

9. A process according to claim 1, which comprises applying an ethylenically unsaturated compound in the form of a monomer, oligomer or polymer.

10. A process according to claim 9, wherein the ethylenically unsaturated monomers, oligomers or polymers are mono-, di-, tri-, tetra- or multi-functional vinyl ethers, acrylates or methacrylates.

11. A process according to claim 1, wherein the plasma is an inert gas or a mixture of inert gas and reactive gas.

12. A process according to claim 11, wherein the gas is H₂, N₂, He, Ar, Kr, Xe, O₂ or H₂O.

13. A process according to claim 1, wherein a liquid is applied in process step b), which liquid contains the initiators in an amount of approximately from 0.01 to 20% by weight.

14. A process according to claim 1, where a liquid is applied in process step b), which liquid contains the UV absorbers in an amount of approximately from 0.1 to 99% by weight.

15. A process according to claim 1, wherein a liquid is applied in process step b), which liquid contains the ethylenically unsaturated compound in an amount of approximately from 0.1 to 50% by weight.

16. A process according to claim 1, wherein a liquid is applied in process step b), which liquid comprises additives selected from the group consisting of defoamers, emulsifiers, surfactants, anti-fouling agents and/or wetting agents.

17. A process according to claim 1, which comprises forming the UV absorber layer in a thickness, in the dry state, from a monomolecular layer up to 2 mm.

18. A process according to claim 1, wherein in process step c), heating is carried out in an oven, with warm gases, heated rollers, IR radiators or with microwaves in order to activate the initiator, a drying step optionally being carried out beforehand.

19. A process according to claim 1, wherein the irradiation in process step c) is carried out using electromagnetic rays of a wavelength of from 200 nm to 20 000 nm or using electron beams, a drying step optionally being carried out beforehand.

20. A process according to claim 1, which comprises carrying out process step c) in an inert gas atmosphere or in air.

21. A substrate having a UV absorber layer, obtained according to a process which comprises
a) allowing a low-temperature plasma, a corona discharge or high-energy radiation to act on an inorganic or organic substrate,
b) applying to the treated inorganic or organic substrate at least one free-radical-forming initiator and at least one UV absorber containing at least one ethylenically unsaturated group, and, optionally in the form of melts, solutions, suspensions or emulsions, at least one synergist and/or at least one ethylenically unsaturated compound and
c) heating the coated substrate and/or irradiating it with electromagnetic waves.

22. A substrate according to claim 21, wherein the UV absorber layer has an optical density of approximately from 0.1 to 6 in the absorption maximum of the UV absorber.

23. A substrate according to claim 22, wherein the optical density is approximately from 1 to 3.

24. A substrate according to claim 21, wherein the proportion of UV absorber in the UV absorber layer is at least approximately 10% by weight.

25. A substrate according to claim 24, wherein the proportion of UV absorber is at least approximately 20% by weight.

26. A substrate according to claim 21 which is an optical filter.
